(19) United States
(12) Patent Application Publication
(10) Pub. No.: US 2017/0098040 A1
(43) Pub. Date: Apr. 6, 2017

(54) WEIGHT MANAGEMENT SYSTEM AND METHOD

(71) Applicant: Scale Down, Chicago, IL (US)

(72) Inventors: Kathleen Y. Wolin, Chicago, IL (US); Dori Steinberg, Chapel Hill, NC (US); Gary G. Bennett, JR., Raleigh, NC (US)

(21) Appl. No.: 15/255,219

(22) Filed: Sep. 2, 2016

Related U.S. Application Data
(60) Provisional application No. 62/237,894, filed on Oct. 6, 2015.

(51) Int. Cl. G06F 19/00; G06F 3/0481

(52) U.S. Cl. CPC G06F 19/322; G06F 3/0481

(57) ABSTRACT

Aspects of the present disclosure relate to data analysis, and in particular, to the monitoring, management, and/or analysis of heath data and/or body weight data obtained from weighing scales and/or body sensors.

### CROSS REFERENCE TO RELATED APPLICATIONS

The present non-provisional utility application claims priority under 35 U.S.C. §119(e) to co-pending provisional application No. 62/237,894 entitled “Weight Management System And Method,” filed on Oct. 6, 2015, and which is hereby incorporated by reference herein.

### TECHNICAL FIELD

Aspects of the present disclosure relate to data analysis, and in particular, to the monitoring, management, and/or analysis of heath data and/or body weight data obtained from weighing scales and/or body sensors.

### BACKGROUND

Digital weighing scales are an important tool used in many weight management programs. Typical digital weighing scales, however, are generally ineffective in providing users with comprehensive and useful information to ensure that the users are engaging in good practices when participating in the weight management program over an extended period of time. For example, in order to measure a given user's success, the user may need to periodically receive information about his/her health and body weight changes over time, as such information may serve as a measure of progress and provide the user with feedback about the effectiveness of the weight management program. Conventional digital weighing scales cannot provide users with such information. It is with these concepts in mind, among others, that various aspects of the present disclosure were conceived.

### SUMMARY

Aspects of the present disclosure include methods, systems, and computer-readable mediums for generating a personalized health data message. The methods, systems, and computer readable mediums involve a memory storing a plurality of pre-defined messages, wherein each pre-defined message of the plurality of pre-defined messages describes an action for a user to motivate the user to participate in a weight loss program, the user engaged at a client device included in a communications network. The methods, systems, and computer readable mediums further involve a server in operable communication with the memory, that generates a personalized message for display at the client device by: generating a graphical user-interface that receives personalized information from the user, the personalized information including body weight information, demographic information, blood glucose information, medication information, and/or weight loss program information; generating a personalized message including at least one pre-defined message of the plurality of pre-defined messages, wherein the at least one pre-defined message is adjusted for the user based on the body weight information, demographic information, and weight loss program information corresponding to the user; and automatically transmitting the personalized message to the client device for display in real-time.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 is a flowchart illustrating an example process for generating or selecting personalized messages relating to a user's body weight, exercise regimen, and/or personal weight loss plan, according to aspects of the present disclosure.

FIG. 2 is block diagram illustrating a health management computing environment, according to aspects of the present disclosure.

FIG. 2B is a flow chart of the Health Management System.

FIG. 3 is a diagram of a computing system, according to aspects of the present disclosure.

### DETAILED DESCRIPTION

Aspects of the present disclosure involve a health management computing architecture and related devices that automatically and in real-time, monitor, manage, and/or process data (e.g., generate messages) related to one or more aspects of personal health, such as body weight, body fat percentage, physical exercise, a weight management program, and/or the like. In various aspects, a health management system included in the health management computing architecture automatically generates and transmits personalized messages to users currently participating in a weight management program. The messages are used as a mechanism to ensure that: the users understand the requirements of the applicable weight management program; the users are actively participating and in compliance with the program; and that the users are properly incentivized to continue to participate in the weight management program.

Other aspects and/or advantages of the health management system, include, but are not limited to, increased duration of a subject's and/or user's participation in a weight loss program, increased compliance with the requirements of a weight loss program (e.g. administration of a weight loss medication, restriction of caloric intake, completion of a prescribed amount of physical activity, etc.), and/or decreased comorbidities (e.g. improved glycemic control, improved blood pressure control, etc.), as compared to individuals participating in the same weight loss program but who are not users of the system.

To generate the personalized messages, the health management system may execute one or more algorithms that generate personalized message(s) relating to a user's body weight, exercise regimen, and/or personal weight loss plan, and subsequently transmit the messages to one or more client devices accessible by the user. In other embodiments, the provided input may be in response to an initial question provided by the health management system, such as via an automatic text, SMS, or the like. The personalized messages may be generated, in part, based on input provided by the user at one or more physical and/or interactive devices, graphical-user interfaces, dashboards, etc., any of which enable the user to provide input related to the user's health and/or body weight. For example, in some embodiments, a user may provide input involving the user's body weight characteristics, diet and food preferences, and/or exercise preferences to a graphical user-interface. In other embodiments, the user may further provide input involving the user's blood glucose level (e.g., via a glucometer device with or without wireless capabilities), ketone levels in urine, A1C percentage, eAG number, and/or medication (e.g. units of insulin administered). In other embodiments, the user may provide such information to an interactive physical device (e.g., a biometric sensor device), such as a digital weighing scale, a blood glucose monitoring device, and/or an insulin pump. All of the input received from the user is processed by the some or all of the various devices within the health management computing architecture to generate the personalized messages for presentation to the user.

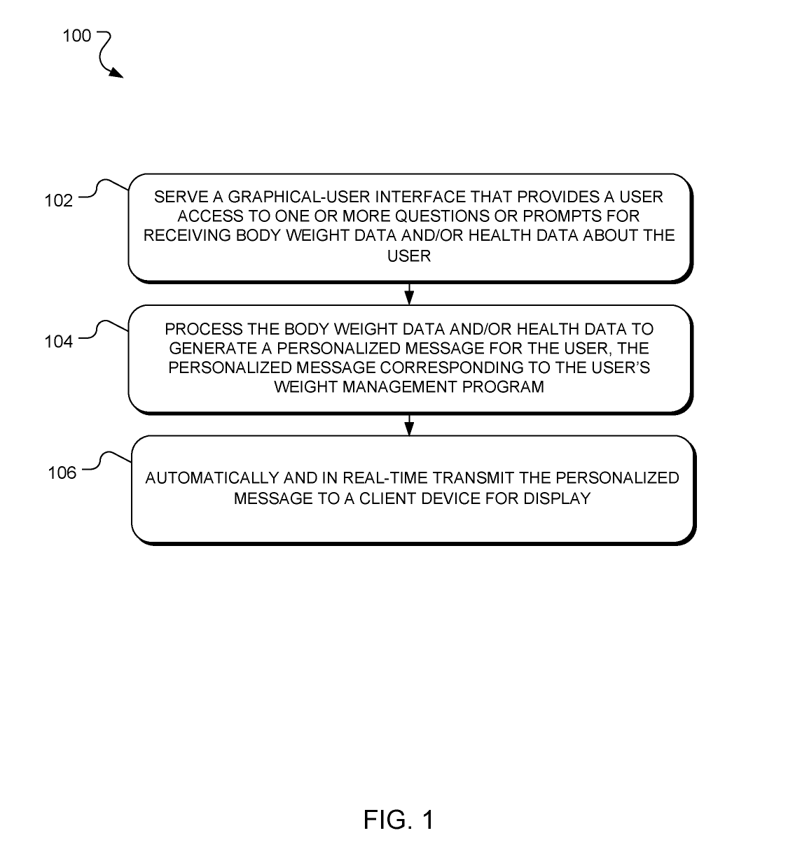

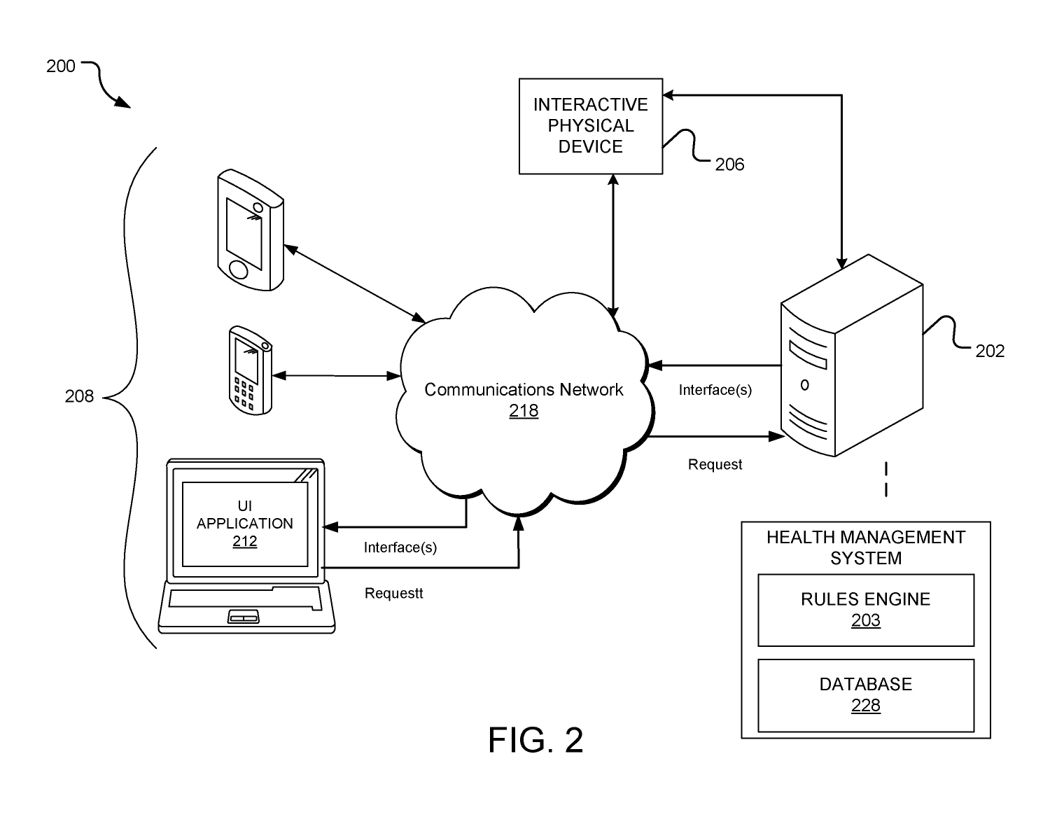

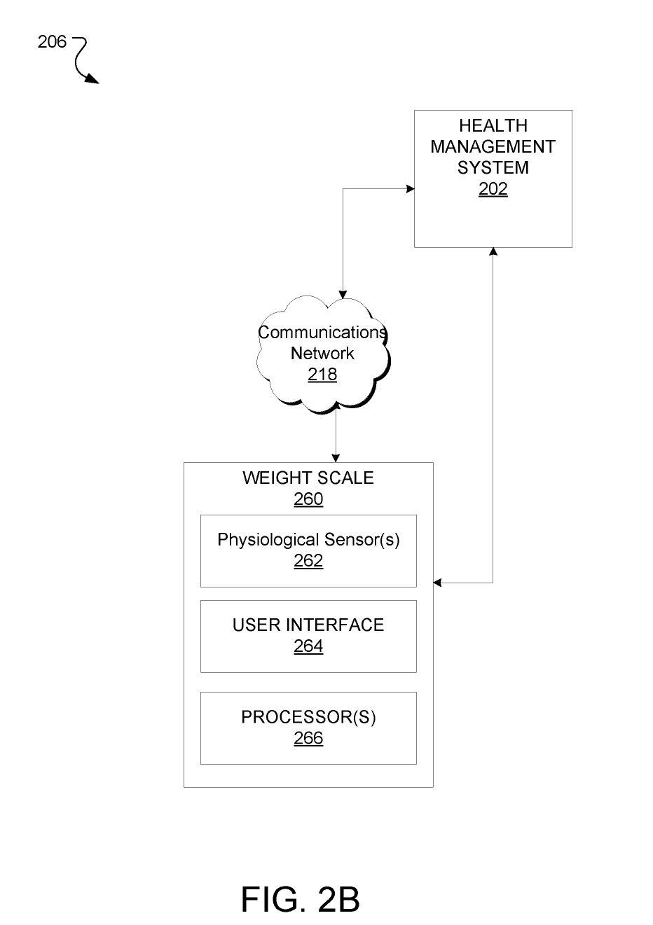

An illustrative process and system for generating or otherwise selecting personalized messages relating to a user's body weight, exercise regimen, and/or personal weight loss goals for presentation to a user participating in a weight loss program is depicted in FIGS. 1-2. In particular, FIG. 1 illustrates an example process 100 for generating the personalized message(s). FIG. 2 illustrates a computing environment 200 including a health management system 202 configured to generate the messages and/or the one or more interfaces (e.g., graphical user-interfaces) capable of receiving health data and/or related information from users. More specifically, FIG. 2 illustrates a computing environment 200 including the health management system 202 (e.g., a web server) operating in conjunction with various other hardware and/or software components that may be used to perform or otherwise execute the process 100.

Referring now to FIG. 1, process 100 begins serving a graphical user-interface that provides users access to one or more questions and/or prompts for receiving body weight and/or health data about the user (operation 102). Referring again to FIG. 1, in one embodiment, the health management system 202 provides a mechanism, such as a graphical user-interface (“GUI”) that includes various interactive components, forms, buttons, selections, forms, fields, streaming capabilities, etc., any of which a user may interact with to provide body weight data and/or health related information corresponding to the user, including information describing the user's current weight loss program (e.g., diet preferences, etc.). For example, in one embodiment, the various interfaces may be used to guide users through a user survey including a series of questions and/or prompts (enabled by the components of the GUI) that allows the user to provide body weight data and/or the health data and information. For example, various GUI screens may include various components that collect a user's initial weight, age, work hours, demographical information (e.g., name, gender, race), height, exercise habits, marital status, child status (i.e., does the user have children and how many), employment, exercise preferences, etc. It is contemplated that any type of health-related information applicable to a user's weight and/or a weight program may be obtained at the interfaces.

In one embodiment and with reference to FIG. 2, some and/or all of the body weight data and/or health data may be received by an interactive physical device 206 that includes one or more sensors for measuring and capturing various body weight data and/or health data of a user, such as body fat, body weight, blood pressure, health data, and/or the like. In other embodiments, the health data may include images, video, audio, interactive media and/or other types of media that relate to datasets involving health and health care. The health data may include information related to health conditions (e.g. diabetes, dyslipidemia, hypertension, chronic kidney disease, cardiovascular disease, depression, cancer, sleep disorders, etc.), reproductive outcomes, causes of death, and quality of life of a particular user.

More specifically, when a user interacts with the physical device 206, a signal may be generated that encapsulates the detected body weight data and/or health data and transmits the signal to the health management system 202 in real-time for processing. For example, in one embodiment, the interactive physical device 206 may be a digital weighing device, such as a body weight scale or weighing scale (e.g., a bathroom scale) on which a user stands to provide the body weight data and/or health data relevant to the user's health, weight requirements and/or over all weight management program. In other embodiments, the interactive physical device 206 may be any one or more of a: mobile device with hand sensors, body fat sensing device, wearable body sensing and weight device, body composition monitoring device, and/or the like (any number of interfaces). In other embodiments, the interactive physical device 206 may be a glucose monitoring device or an insulin pump, any of which may interface with the health management system 202 and/or other component of the computing environment 200 capable of communicating with the health management system 202.

FIG. 2B provides an illustration of an example interactive physical device 206 in the form of a weight scale 260, according to one embodiment. As illustrated, the weight scale 260 includes one or more physiological sensors 262, a user interface 264 and one or more processors 266. The physiological sensors 262 detect, measure, and/or otherwise sense data corresponding to various physiological characteristics representative of a user, such as the weight of the user, heart rate, respiratory rate, hydration, height, sun exposure, blood pressure, body fat, and/or the like, and/or any combination thereof.

The user interface 264 of the weight scale 260 facilitates exchange of physiologic information and other health information or data. For example, the weight scale 260 may include one or more interactive interfaces or displays to present physiologic information and/or health data such as historical weight and/or body fat data measured and/or otherwise sensed by the weight scale 260 (which may be stored internally to and/or externally from the weight scale 260), historical user activity data, food consumption data, and/or sleep data (which may be measured or monitored by other personal and/or portable devices), historical user biometric or physiologic data (for example, heart rate, blood pressure, arterial stiffness, blood glucose levels, cholesterol, duration of TV watching, duration of video game play, stress and/or mood data, among others. Any of such data may be presented in pictorial, graphical and/or textual form at the user interface 264 of the weight scale 260.

In some embodiments, the user interface 264 may include an input mechanism to facilitate the input of user data, commands, and/or selections. For example, the user interface 260 may include a touch pad, touch screen, buttons, switches and/or knobs. In another embodiment, the user interface 264 may include one or more audio sensors to detect speech or sounds. For example, in response to speech or sounds from the user, the weight scale 260 may determine or identify the appropriate user (for example, from a list stored therein) which facilitates correlation of physiologic data (acquired by the one or more physiological sensors) with a particular user. In yet another embodiment, the user interface 264 may include one or more biometric sensors to identify or determine a particular user and/or a touch screen to facilitate selection of a particular user or user profile. Additionally, the weight scale 260 may, in addition to correlating the current physiologic data with the particular user, present the associated historical information to the user via visual and/or audio techniques of user interface 264.

As noted above, in one embodiment, the weight scale 260 may include one or more processors 266 that process and generate physiologic informational metrics using data sensed, detected and/or measured from physiological sensor(s) 262. For example, the one or more processors 266 may calculate a user's weight based on weight data obtained from the physiological sensors 264. In another embodiment, using data from a body fat sensor (e.g., via bioelectrical impedance analysis (BIA) electrodes), the one or more processors 206 may determine a user's body fat composition and/or body mass index. More specifically, via the BIA electrodes, a small current is applied to the body and the characteristics of the return current measured in the electrodes are representative of the body fat composition of the user. The one or more processors 266, based on data acquired or detected by the BIA electrodes and in combination with information about the user (e.g., weight, height, age, and gender), may calculate or determine a user's body fat composition and/or body mass index. In another embodiment, the one or more processors 266 may calculate a user's weight trajectory, fat composition trajectory and/or body mass index trajectory based on weight data and/or body mass data obtained from the physiological sensors 264 and historical weight and/or body fat data (which may be stored internally to and/or externally from the weight scale 260). A “trajectory” refers to a general pattern of gain or loss over time, and may be calculated from any two or more, preferably three or more, data points. The one or more processors may employ similar measurement methods to derive a user's fat-free mass, hydration (e.g., total body water, intracellular water, and/or extracellular water) and body cell mass.

The one or more processors 266 may also calculate and/or otherwise determine other biometric or physiological quantities such as heart rate, blood pressure and/or arterial stiffness. For example, weight scale 260 may include one or more LED/photodetector pairs disposed therein such that when the user placing blood-perfused area of the foot (for example, the big toe) over the one or more LED/photodetector pairs, the weight scale 260 may perform photo plethysmography to determine heart rate, respiratory rate, blood pressure and/or arterial stiffness. Any of the data collected by the weight scale may be directly transmitted to the health management system and/or transmitted to the health management system 202 via the communications network 218.

Referring again to FIG. 2, once any body weight and/or health data has been received from a user, the data may be processed to generate a personalized message related to the user's weight management program (operation 104). Referring to FIG. 2, the health management system 202 may execute various algorithms that process the received body weight data and health data and generate the personalized messages that relate to the user's specific set of health and body weight circumstances. In some embodiments, the health management system 202 may include a database 228 for storing and/or retrieving the generated (or pre-generated and therefore selectable) personalized messages for each user. Although the database 228 of FIG. 2 is depicted as being located within the health management system 202, it is contemplated that the database 228 may be located external to the health management system 202, such as at a remote location, and may communicate with the health management system 202.

In one embodiment, the health management system 202 may execute a rules engine 203 that determines what message should be generated for a given user. More specifically, the rules engine 203 of the health management system 202 may use the provided health data to execute a series of rules received from a user to identify one or more relevant and pre-defined text messages (or other type of message) from the database 228 (maintained and/or stored in the database according to pools/topics) that should be included within the personalized message. In various embodiments, the messages are or otherwise include portions of information that help guide and/or instruct the user to engage in specific and desirable behaviors that will allow the users to reach goals associated with the weight loss program. The rules represent a series of pre-established logical statements (e.g., if-then statements), which when executed, either define or constrain some aspect of the personalized message being generated for the user. Stated differently, the rules may be used to quantify, qualify, and/or validate the messages being provided to the user. Thus, in the context of identifying a text message, the rules are executed in conjunction with the processing of the body weight data and/or health data corresponding to a particular user to identify one or more relevant messages that should be included as part, or all, of the personalized message provided to the particular user.

As an example, the rules engine 203 may execute a rule that identifies relevant messages to be included in the personalized message based on the time at which the user provided input to the interactive device 206 (e.g., a weighing scale), such as the time of day, month, or year, or other temporal delineation. As another example, the rules engine 203 may execute a rule that identifies messages for inclusion into the personalized message based on the frequency or regularity at which the user provided input to the interactive device 206 (e.g. a weighing scale). In yet another example, the rules engine 203 may execute a rule that identifies messages for inclusion into the personalized message based on environmental aspects (e.g., weather) at the time at which the user provides input to the interactive device 206. The messages, via the rules, can be further personalized with the user's name and additional demographical information about the user, or health information about the user, or information specific to the program in which the user is enrolled.

In some embodiments, the content of the messages (e.g., each of the pre-defined messages and/or the personalized messages) may be logically maintained in memory of the health management system 202 in a manner that allows for automatic encapsulation into the generated messages, such as the pre-defined messages and/or the personalized messages. More specifically, the content of the messages may be pooled into general pool categories that represent a particular type of content that is applicable to a user and useful when identifying messages applicable to the user and/or generating personalized messages for the user (e.g., specific to the users weight, weight program, blood glucose, and/or the like). For example, various pools of content may include: stress (e.g., managing stress), work-life balance; sleep, food, social eating, stimulus, caloric intake (e.g., more volume, fewer calories), exercise, disease management, stretching, sitting and/or standing, strength training, staying motivated, plateauing, health news, kids, among others. In some embodiments, the content pools may include sub-pools and/or otherwise be associated with sub-pools. Accordingly, the exercise pool may include sub-pools and/or associated pools, such as “exercise indoors” and “exercise outdoors” pools. The stress pool may include sub-pools and/or associated pools such as, “stress at work” and/or “stress at home” pools. It is contemplated that any one of the general pools may include one or more sub-pools and/or otherwise be related to one or more sub-pools of content.

Each of the content pools may include a series of specific messages. For example, the stress pool category may include a series of specific messages including: “what is stress”; “where does stress come from”; “why is stress bad”; “how does stress effect weight”; and so on. In the event that the stress content pool includes a sub-pool and/or is otherwise associated with a sub-pool such as “stress work”, such a pool may include messages such as: “what is stress”; “what is toxic work stress”; “what makes stress at work bad”; “is all work stress bad”; and so on.

The pools of categories may be stored in memory in a data structure corresponding to the pooling, thereby allowing the health management system 202 to automatically and efficiently access the data. Stated differently, the computational cost of accessing the content data-sets via the category pooling reduces the computational cost of accessing the data, when compared to accessing each separate piece of data content. Referring generally again to FIG. 2 and as explained above, the rules engine may logically and automatically identify any of the various pools of message content for a user, based on input provided by the user.

An illustrative example of a user providing input to the health management system 202 via the interactive device 206 will now be provided. Assume a user is interested in starting a weight management program over a six (6) month period. Assuming the interactive device 206 is a body weighing scale (e.g., weight scale 260), the user may stand on the interactive device to provide body weight measurement as a specific point in time. In response, the interactive device may generate a signal that encapsulates or is otherwise modulated with the body weight data and subsequently transmitted to the health management system 202 in real-time. In response, the health management system 202 may continuously, during the six month period, or at predetermined time intervals, generate personalized messages for presentation to the user that provide the user with relevant information with respect to their participation in the weight management program, success, milestones, accomplishments, and/or the like. The personalized messages may include one or more of the pre-defined massages included in the content pools stored in memory, adjusted to fit the specific needs of the user. Alternatively, the generated personalized messages may include information suggesting useful tips on how the user could better perform during the weight management program, such as for example providing: useful reminders to the user on when to exercise, specific exercise instructions and tutorials, food and nutritional information, reminders or prompts to take medication, etc.

Referring back to FIG. 1, once the personal messages have been generated, one or more interactive interfaces/input forms (e.g. a user-interface or graphical user-interface) may be generated for displaying the messages to users (operation 106). Referring to FIG. 2, the messages may be displayed at one or more client device(s) 208, which may be a personal computer, work station, mobile device, mobile phone, tablet device, processor, and/or other processing device capable of implementing and/or executing processes, software, applications, etc. Additionally, the one or more client device(s) 208 may include one or more processors that process software or other machine-readable instructions and may include a memory to store the software or other machine-readable instructions and data. The one or more client device(s) 208 may also include a communication system to communicate with the various components of the health management system 202 via a wireline and/or wireless communications, such as through a network 218, such as the Internet, an intranet, an Ethernet network, a wireline network, a wireless network, a mobile communications network, and/or another communication network. The various interactive interfaces generated in response to a monitoring request may be displayed at the one or more client device(s) 208.

A user interested in viewing the generated personal messages may interact with the one or more client device(s) 208 to initiate a request, which may be received by the health management platform 202. More particularly, the one or more client device(s) 208 may also include a user interface (“UI”) application 212, such as a browser application, to generate a request for receiving messages from the health management system 202. In response, the health management system 202 may transmit instructions that may be processed and/or executed to generate, or otherwise display, the various interfaces generated the health management system 202 for presenting the personalized messages to users. In another embodiment, the health management system 202 and the one or more client device(s) 208 may functionally communicate according to a push relationship, in which the health management system 202 may automatically push the generated personalized messages to users interacting with the one or more client device(s) 208 without a user's request. To facilitate in the transmission of the personalized messages, the health management system 202 may employ various cloud communication services, such as Twilio, and/or the like, third party applications, and/or any other cloud communication services capable of delivering the message via text, phone, voice, push, fax, and/or the like.

In some embodiments, a report, summary, or other standardized format of information containing the personalized messages may be generated and subsequently provided to a user. More particularly, the health management system 202 may process any of the generated messages and corresponding body weight and/or health data into a standardized report structure including some form of master data document populated with various health data analytics or other body weight data. Example embodiments include an e-mail, csv files, Internet-accessible formats such as a markup document, pdf, and the like. Additionally, the health data and/or body weight data embedded within or otherwise involve some type of interactive media, such as audio, video, audio-video, multimedia, streaming and/or the like. Any of such media formats may be transmitted from the health management system 202 to one or more of the client device(s) 208 for access by users. In yet other embodiments, the personalized messages may be provided directly and automatically (e.g., via a separate “affiliate” dashboard/portal or through an API) to a 3^{rd} party computing system such as a health care provider server, or payer or employer or employee wellness platform, weight and health management platform (e.g., Weight Watchers™) or chronic disease management platform.

In other embodiments, a personalized health data message to the user or client device for display in real-time may be generated within at least 5, 10, 15, 20, 25, 30, 35, 40, 45, 50, 55, or 60 seconds from the time of generating a graphical user-interface that receives personalized information from the user, the personalized information including body weight information, demographic information, blood glucose information, medication information, and/or weight loss program information. In some embodiments, a personalized health data message to the user or client device for display in real-time may be generated within at least 1, 2, 3, 4, 5, 10, 15, 20, 25, 30, 35, 40, 45, 50, 55, or 60 minutes from the time of generating a graphical user-interface that receives personalized information from the user, the personalized information including body weight information, demographic information, blood glucose information, medication information, and/or weight loss program information. In some embodiments, a personalized health data message to the user or client device for display in real-time may be generated and automatically transmitted to the client device within at least 1, 2, 3, 4, 5, 10, 15, 20, 25, 30, 35, 40, 45, 50, 55, or 60 minutes from the time of generating a graphical user-interface that receives personalized information from the user, the personalized information including body weight information, demographic information, and weight loss program information. In one embodiment, the personalized health data message is a reminder to take medication.

In some embodiments, a personalized health data message to the user or client device for display in real-time may be generated without repeating a previous personalized health data message to that same user. In some embodiments, a personalized health data message to the user or client device for display in real-time from the rules engine 203 may be new and unique to that user at least 90, 91, 92, 93, 94, 95, 96, 97, 98, 99, or 100% of the time. Alternatively, a personalized health data message to the user or client device for display in real-time from the rules engine 203 may be new and unique to that user at least 95-100%, 96-100%, 97-100%, 98-100%, 99-100%, or 99.5-100.0% of the time.

The system for generating a personalized health data may be weekly-focused and/or include in-vivo probes (IVPs). An IVP may include one or more questions to a user. An IVP may be a pre-defined text message from the rules engine 203 based on the time at which the user provided input to the interactive device 206 and may be sent on a pre-determined day of the week. In another embodiment, an IVP may be sent mid-day on a weekday. In yet another embodiment, an IVP is not delivered on weekends or Mondays. Response options by the user to an IVP may have a numerical prefix. The purpose of an IVP may be to gather data that to be used to better personalize future weekly topic/exercise selections for a user. Another purpose of an IVP may be to update data collected at baseline from a user. Yet another purpose of an IVP may be to stimulate user engagement. In some embodiments, the system for generating a personalized health data message may not include any input for counting calories or counting exercise activities.

In some embodiments, an IVP may be sent in response to an event, such as when a user satisfies an aspect of a health regimen or program. For example, the health management system 202 may detect that a user is within an acceptable weight range (e.g., below a certain weight, or above a certain weight), and in response, an IVP may automatically be sent to a user. As another example, an event may involve a user not responding to the health management system 202 for a pre-determined period of time. In yet another embodiment, an event may be when a user interacts with a client device in a manner that is irregular to their normal participation in the weight management program.

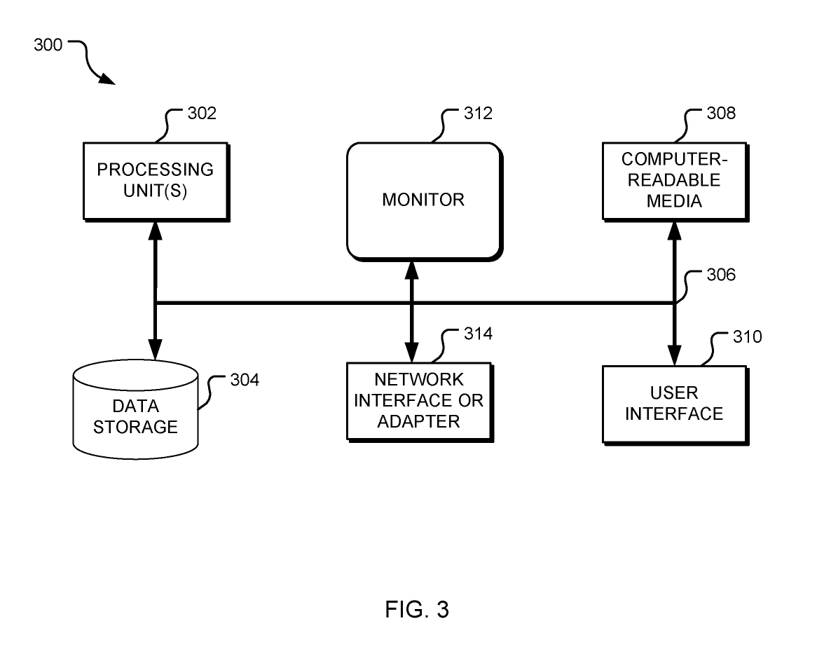

FIG. 3 illustrates an example of a suitable computing and networking environment 300 that may be used to implement various aspects of the present disclosure described in FIGS. 1-2, such as for example the health management system 202. As illustrated, the computing and networking environment 300 includes a general purpose computing device 300, although it is contemplated that the networking environment 300 may include one or more other computing systems, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

Components of the computer 300 may include various hardware components, such as a processing unit 302, a data storage 304 (e.g., a system memory), and a system bus 306 that couples various system components of the computer 300 to the processing unit 302. The system bus 306 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 300 may further include a variety of computer-readable media 308 that includes removable/non-removable media and volatile/nonvolatile media, but excludes transitory propagated signals. Computer-readable media 308 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computer 300. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The data storage or system memory 304 includes computer storage media in the form of volatile/nonvolatile memory such as read only memory (ROM) and random access memory (RAM). A basic input/output system (BIOS), containing the basic routines that help to transfer information between elements within the computer 300 (e.g., during start-up) is typically stored in ROM. RAM typically contains data and/or program modules that are immediately accessible to and/or presently being operated on by processing unit 302. For example, in one embodiment, data storage 304 holds an operating system, application programs, and other program modules and program data.

Data storage 304 may also include other removable/non-removable, volatile/nonvolatile computer storage media. For example, data storage 304 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media, described above and illustrated in FIG. 3, provide storage of computer-readable instructions, data structures, program modules and other data for the computer 300.

A user may enter commands and information through a user interface 310 or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices are often connected to the processing unit 302 through a user interface 310 that is coupled to the system bus 306, but may be connected by other interface and bus structures, such as a parallel port, game port or a universal serial bus (USB). A monitor 312 or other type of display device is also connected to the system bus 306 via an interface, such as a video interface. The monitor 312 may also be integrated with a touch-screen panel or the like.

The computer 300 may operate in a networked or cloud-computing environment using logical connections of a network interface or adapter 314 to one or more remote devices, such as a remote computer. The remote computer may be a personal computer, a server, a router, a network PC, a peer device or other common network node, and typically includes many or all of the elements described above relative to the computer 300. The logical connections depicted in FIG. 3 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 300 may be connected to a public and/or private network through the network interface or adapter 314. In such embodiments, a modem or other means for establishing communications over the network is connected to the system bus 306 via the network interface or adapter 314 or other appropriate mechanism. A wireless networking component including an interface and antenna may be coupled through a suitable device such as an access point or peer computer to a network. In a networked environment, program modules depicted relative to the computer 300, or portions thereof, may be stored in the remote memory storage device.

As noted above, a health management system as described herein provides many advantages to a user participating in a weight loss program as compared to an individual in the same weight loss program who is not a user of the system. In some embodiment, the present disclosure provides a method for increasing the duration a user participates in a weight loss program. In other embodiments, the present disclosure provides a method for increasing a user's compliance with a requirement of a weight loss program. For example, a requirement of certain weight loss programs may be self-administration of a medication. In one embodiment, the medication is metformin, dapagliflozin, insulin, glucose, or dextrose. Other requirements may include, but are not limited to, a restriction of caloric intake or completion of prescribed amount of physical activity by the user at regular intervals. As compared to an individual in the same weight loss program who is not a user of the system, the increase in each of the above embodiments may be at least 10%, at least 25%, at least 50%, or at least 75%. Alternatively, the increase in each of the above embodiments may be about 2-fold, 3-fold, 4-fold, 5-fold, 6-fold, 7-fold, 8-fold, 9-fold, 10-fold, or more.

Providing a user with feedback on the user's personalized information (e.g. body weight information, demographic information, blood glucose information, medication information, and/or weight loss program information), via the personalized messages generated by the system and automatically transmitted to the user, can also result in an improvement in compliance with medications for weight loss or other comorbid conditions. In the case of weight loss medications, the result is greater weight loss. In some embodiments, the comorbidity may be diabetes or prediabetes and the result is improved glycemic control. Methods of measuring glycemic control are known in the art and include, but are not limited to, measuring blood glucose levels and/or hemoglobin A1c (HbAlc) levels. In other embodiments, the comorbidity may be hypertension and the result is improved blood pressure control.

A particular advantage of the methods described above is that the personalized message for the user, generated by the system and automatically transmitted to the user, is adjusted based on the user's body weight information, demographic information, and weight loss program information. In some embodiments, the personalized message for the user is adjusted when the user's body weight increases. In other embodiments, the personalized message for the user is adjusted when the user's body weight decreases. In still other embodiments, the personalized message for the user is adjusted when the user's body weight trajectory, fat composition trajectory and/or body mass index trajectory either increases or plateaus. An increase or a plateau in a user's body weight trajectory, fat composition trajectory and/or body mass index trajectory can indicate the user is not compliant with an aspect of the weight loss program (e.g. not self-administering a medication as required). In yet other embodiments, the personalized message for the user is adjusted when the user does not provide personalized information to the system at regular intervals (e.g. once a month, twice a month, once a week, at least three times a week, at least twice a week, at least once a day). In an alternative embodiment, the invention is a system for improving weight loss through improving blood glucose control of a user. In such an embodiment, the invention is a system for generating a personalized health data message comprising: a memory storing a plurality of pre-defined messages, wherein each pre-defined message of the plurality of pre-defined messages describes an action for a user to motivate the user to participate in a blood glucose control program, the user engaged at a client device in a communications network; and a server in operable communication with the memory, that generates a personalized message for display at the client device by: generating a graphical user-interface that receives personalized information from the user, the personalized information including blood glucose information; generating a personalized message including at least one pre-defined message of the plurality of pre-defined messages, wherein the at least one pre-defined message is adjusted for the user based on demographic information or blood glucose information corresponding to the user; and automatically transmitting the personalized message to the client device for display in real-time. The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

What is claimed is:

1. A system for generating a personalized health data message comprising:
a memory storing a plurality of pre-defined messages, wherein each pre-defined message of the plurality of pre-defined messages describes an action for a user to motivate the user to participate in a weight loss program, the user engaged at a client device included in a communications network; and
a server in operable communication with the memory, that generates a personalized message for display at the client device by:
generating a graphical user-interface that receives personalized information from the user, the personalized information including body weight information, demographic information, and weight loss program information;
generating a personalized message including at least one pre-defined message of the plurality of pre-defined messages, wherein the at least one pre-defined message is adjusted for the user based on the body weight information, demographic information, and weight loss program information corresponding to the user; and
automatically transmitting the personalized message to the client device for display in real-time.

2. The system of claim 1, wherein the personalized information including body weight information, demographic information, and the weight loss program information is received at an interactive weight scale, in response to the user interacting with the interactive weight scale.

3. The system of claim 2, wherein the interactive weight scale comprises:
a platform to receive at least one foot of the user, wherein the platform is capable of supporting the weight of the user;
a weight sensor operatively coupled to the platform, to generate sensor data corresponding to the weight of the user;
at least one processor operative connected to the weight sensor to calculate a weight of the user based on the sensor data; and
communication circuitry to communicate the weight of the user to the client device.

4. The system of claim 2, wherein the system is configured to generate the graphical user-interface, generate the personalized message, and automatically transmitting the personalized message at the time at which the user interacted with the interactive weight scale.

5. The system of claim 1, wherein generating the personalized message comprises:
processing the body weight information, demographic information, and the weight loss program information at a rules engine to identify the at least one pre-defined message included in the personalized message, wherein the rules engine identifies the at least one pre-defined message based in part on a time at which the client device receives the personalized information from the user.

6. The system of claim 1, further comprising:
adjusting the personalized message for the subject when the user's body weight increases or decreases; and
wherein the adjusted personalized message includes a different pre-defined message of the plurality of pre-defined messages than the at least one pre-defined message of the personalized message.

7. The system of claim 1, wherein the message is a text message and wherein the client device is included in a health management computing architecture deployed in the communications network.

8. A method for generating a personalized health data message comprising:
generating a graphical user-interface that receives personalized information from a user, the personalized information including body weight information, demographic information, and weight loss program information;
generating a personalized message including at least one pre-defined message of a plurality of pre-defined messages, wherein each pre-defined message of the plurality of pre-defined messages describes an action for a user to motivate the user to participate in a weight loss program, the user engaged at a client device included in a in a communications network; wherein the at least one pre-defined message is adjusted for the user based on the body weight information, demographic information, and weight loss program information corresponding to the user; and
transmitting the personalized message to the client device for display in real-time.

9. The method of claim 7, wherein the personalized information including body weight information, demographic information, and the weight loss program information is received at an interactive weight scale, in response to the user interacting with the interactive weight scale.

10. The method of claim 8, wherein the interactive weight scale comprises:
a platform to receive at least one foot of the user, wherein the platform is capable of supporting the weight of the user;
a weight sensor operatively coupled to the platform, to generate sensor data corresponding to the weight of the user;
at least one processor operative connected to the weight sensor to calculate a weight of the user based on the sensor data; and
communication circuitry to communicate the weight of the user to the client device.

11. The method of claim 8, wherein the system is configured to generate the graphical user-interface, generate the personalized message, and automatically transmitting the personalized message at the time at which the user interacted with the interactive weight scale.

12. The method of claim 7, wherein generating the personalized message comprises:
processing the body weight information, demographic information, and the weight loss program information at a rules engine to identify the at least one pre-defined message included in the personalized message, wherein the rules engine identifies the at least one pre-defined message based in part on a time at which the client device receives the personalized information from the user.

13. The method of claim 7, further comprising:
adjusting the personalized message for the subject when the user's body weight increases or decreases; and
wherein the adjusted personalized message includes a different pre-defined message of the plurality of pre-defined messages than the at least one pre-defined message of the personalized message.

14. The method of claim 7, wherein the message is a text message and wherein the client device is included in a health management computing architecture deployed in the communications network.

15. A method for increasing the duration a user participates in a weight loss program, the method comprising:
providing personalized information to a system of claim 1 from a user participating in a weight loss program, wherein the personalized information is selected from body weight information, demographic information, weight loss program information, or any combination thereof; and
automatically transmitting a personalized message from the system to the user that describes an action for the user to motivate the user to participate in the weight loss program,
wherein the duration of the user's participation in the weight loss program is increased compared to an individual in the weight loss program that does not receive automatically transmitted personalized messages.

16. The method of claim 15, wherein the system adjusts the personalized message for the subject when the user's body weight increases or decreases; and
wherein the adjusted personalized message includes a different pre-defined message of the plurality of pre-defined messages than the at least one pre-defined message of the personalized message.

17. The method of claim 15, wherein the system adjusts the personalized message for the subject when the user's weight trajectory, fat composition trajectory and/or body mass index trajectory plateaus or increases; and
wherein the adjusted personalized message includes a different pre-defined message of the plurality of pre-defined messages than the at least one pre-defined message of the personalized message.

18. The method of claim 15 further comprising providing an interactive weight scale to the user, wherein the personalized information is received at the interactive weight scale in response to the user interacting with the interactive weight scale and then provided to the system.

19. The method of claim 18 further comprising transmitting the personalized message at the time at which the user interacts with the interactive weight scale.

20. The method of claim 18, wherein the user interacts with the interactive weight scale at a regular interval.

21. The method of claim 20, wherein the regular interval is at least once a week, at least three times a week, or daily.

22. The method of claim 20, wherein the system adjusts the personalized message for the subject when the user does not interact with the interactive weight scale at a regular interval; and
wherein the adjusted personalized message includes a different pre-defined message of the plurality of pre-defined messages than the at least one pre-defined message of the personalized message.

23. A method for increasing a user's compliance with a requirement of a weight loss program, the method comprising:
providing personalized information to a system of claim 1 from a user participating in a weight loss program, wherein the personalized information is selected from body weight information, demographic information, weight loss program information, or any combination thereof; and
automatically transmitting a personalized message from the system to the user that describes an action for the user to motivate the user to participate in the weight loss program,
wherein the user's compliance with a requirement of the weight loss program is increased as compared to an individual in the weight loss program that does not receive automatically transmitted personalized messages, and wherein the requirement of the weight loss program is self-administration of a medication by the user at regular intervals.

24. The method of claim 23 further comprising providing an interactive weight scale to the user, wherein the personalized information is received at the interactive weight scale in response to the user interacting with the interactive weight scale and then provided to the system.

25. The method of claim 24 further comprising transmitting the personalized message at the time at which the user interacted with the interactive weight scale.

26. The method of claim 23, wherein the system adjusts the personalized message for the user when the user's body weight increases; and
wherein the adjusted personalized message includes a different pre-defined message of the plurality of pre-defined messages than the at least one pre-defined message of the personalized message, and the adjusted personalized message motivates the user to administer the medication as required by the weight loss program.

27. The method of claim 23, wherein the system adjusts the personalized message for the user when the user's body weight trajectory, fat composition trajectory and/or body mass index trajectory either increases or plateaus; and
wherein the adjusted personalized message includes a different pre-defined message of the plurality of pre-defined messages than the at least one pre-defined message of the personalized message, and the adjusted personalized message motivates the user to administer the medication as required by the weight loss program.

28. A method for improving glycemic control in a user, the method comprising
providing personalized information to a system of claim 1 from a user self-administering a medication prescribed to improve glycemic control and participating in a weight loss program, wherein the personalized information is selected from body weight information, demographic information, weight loss program information, or any combination thereof; and
automatically transmitting a personalized message from the system to the user that describes an action for the user to motivate the user to participate in the weight loss program,
wherein the user's glycemic control is increased as compared to an individual self-administering the medication and participating in the weight loss program that does not receive automatically transmitted personalized messages.

29. The method of claim 28 further comprising providing an interactive weight scale to the user, wherein the personalized information is received at the interactive weight scale in response to the user interacting with the interactive weight scale and then provided to the system.

30. The method of claim 29, further comprising transmitting the personalized message at the time at which the user interacted with the interactive weight scale.

31. The method of claim 28, wherein the system adjusts the personalized message for the user when the user's body weight increases; and
wherein the adjusted personalized message includes a different pre-defined message of the plurality of pre-defined messages than the at least one pre-defined message of the personalized message, and the adjusted personalized message motivates the user to administer the medication as required by the weight loss program.

32. The method of claim 28, wherein the system adjusts the personalized message for the user when the user's body weight trajectory, fat composition trajectory and/or body mass index trajectory either increases or plateaus; and
wherein the adjusted personalized message includes a different pre-defined message of the plurality of pre-defined messages than the at least one pre-defined message of the personalized message, and the adjusted personalized message motivates the user to administer the medication as required by the weight loss program.

33. A system for generating a personalized health data message comprising:
a memory storing a plurality of pre-defined messages, wherein each pre-defined message of the plurality of pre-defined messages describes an action for a user to motivate the user to participate in a blood glucose control program, the user engaged at a client device included in a in a communications network; and
a server in operable communication with the memory, that generates a personalized message for display at the client device by:
generating a graphical user-interface that receives personalized information from the user, the personalized information including blood glucose information;
generating a personalized message including at least one pre-defined message of the plurality of pre-defined messages, wherein the at least one pre-defined message is adjusted for the user based on demographic information or blood glucose information corresponding to the user; and
automatically transmitting the personalized message to the client device for display in real-time.
